(19) United States
(12) Patent Application Publication
(10) Pub. No.: US 2020/0256536 A1
(43) Pub. Date: Aug. 13, 2020

(54) LIGHTING APPARATUS

(71) Applicant: HONDA MOTOR CO., LTD., Tokyo (JP)

(72) Inventor: Tokujiro Kizaki, Wako-shi (JP)

(21) Appl. No.: 16/740,894

(22) Filed: Jan. 13, 2020

(30) Foreign Application Priority Data
Feb. 13, 2019 (JP) 2019-023612

(51) Int. Cl. F21S 41/24; F21S 45/47; B62J 6/026

(52) U.S. Cl. CPC F21S 41/24; F21W 2107/17; B62J 6/026; F21S 45/47

(57) ABSTRACT

A light guide member, and light source groups as light guide member light sources that emit light to be guided to the light guide member, constitute a subsidiary lighting body, and the light guide member is disposed around reflectors. The light source groups are disposed at upper end portions of the light guide member. The light source groups consume electricity more than low-beam light sources and high-beam light sources do. Substrates, on which the light source groups are mounted, are mounted together with heat sinks on a housing main body.

### INCORPORATION BY REFERENCE

The present application claims priority under 35 U.S.C. § 119 to Japanese Patent Application No. 2019-023612 filed on Feb. 13, 2019. The content of the application is incorporated herein by reference in its entirety.

### TECHNICAL FIELD

The present invention relates to a lighting apparatus.

### BACKGROUND ART

A hitherto known configuration of a lighting apparatus includes a pair of left and right first light sources emitting a high beam and a low beam and a pair of left and right second light sources causing a light guide member to emit light (see, for example, Patent Document 1).

The lighting apparatus described above lights up the left and right first light sources and the left and right second light sources in a high-beam mode. In a low-beam mode, the above lighting apparatus lights up either one of the first light sources and the left and right second light sources.

### PRIOR ART DOCUMENT

### Patent Document

[Patent Document 1]

Japanese Patent No. 6270679

### SUMMARY OF THE INVENTION

### Problem to be Solved by the Invention

In the configuration disclosed in Patent Document 1, the left and right first light sources and the left and right second light sources are all lit up in the high-beam mode, which causes temperature inside a housing of the lighting apparatus to rise. Thus, a thermal effect on the first light sources, the second light sources, and other components in the housing can be a concern.

An object of the present invention is to provide a lighting apparatus that can reduce a thermal effect inside a housing.

### Means for Solving the Problem

An aspect of the present invention provides a lighting apparatus that includes: a housing (61); a lens (51) that covers a front surface of the housing (61); a main lighting body (65) housed in the housing (61), the main lighting body (65) emitting light; a reflector (69) that reflects light from main lighting body light source (67, 68) included in the main lighting body (65) anteriorly; a light guide member (71) disposed around the reflector (69); and an extension (72) that partially covers the light guide member (71) from a front. In the lighting apparatus, the light guide member (71), and a light guide member light source (77) that emits light to be guided to the light guide member (71), constitute a subsidiary lighting body (66). The light guide member light source (77) is disposed at an upper end portion of the light guide member (71). The light guide member light source (77) consumes electricity more than the main lighting body light source (67, 68) does. A substrate (82), on which the light guide member light source (77) is mounted, is mounted together with a heat sink (91) on the housing (61).

In the foregoing configuration, preferably, the light guide member (71) extends from the light guide member light source (77) along an optical axis (103) of the light guide member light source (77) in an area near the light guide member light source (77).

In the foregoing configuration, preferably, the light guide member light source (77) is disposed to be offset vertically with respect to the main lighting body light source (67, 68), and the light guide member light source (77) is disposed superior to the main lighting body light source (67, 68).

In the foregoing configuration, preferably, the light guide member light source (77) is disposed at each left and right end portion of the light guide member (71), and each left and right end portion of the light guide member (71) is located at an uppermost portion of the light guide member (71).

In the foregoing configuration, preferably, the main lighting body (65) is a two-headlight type, the light guide member (71) is formed into an co-shape to cover peripheries of the two-headlight main lighting bodies (65), and a central portion (71d) of the light guide member (71) is located at a frontmost portion.

### Effects of the Invention

The lighting apparatus includes: the housing; the lens that covers the front surface of the housing; the main lighting body, housed in the housing, for emitting light; the reflector that reflects light from the main lighting body light source included in the main lighting body anteriorly; the light guide member disposed around the reflector; and the extension that partially covers the light guide member from the front. In the lighting apparatus, the light guide member, and the light guide member light source that emits light to be guided to the light guide member, constitute the subsidiary lighting body. The light guide member light source is disposed at the upper end portion of the light guide member. The light guide member light source consumes electricity more than the main lighting body light source does. The substrate, on which the light guide member light source is mounted, is mounted together with the heat sink on the housing. The foregoing configuration, in which the light guide member light source is disposed at the upper end portion of the light guide member and the light guide member light source that consumes a large amount of electricity are mounted together with the heat sink on the housing, allows a thermal effect inside the lighting apparatus to be reduced.

In the foregoing configuration, the light guide member extends from the light guide member light source along the optical axis of the light guide member light source in the area near the light guide member light source. The foregoing configuration allows light leak from the light guide member to be reduced and the light guide member to be illuminated even more brightly.

In the foregoing configuration, the light guide member light source is disposed to be offset vertically with respect to the main lighting body light source, and the light guide member light source is disposed superior to the main lighting body light source. The foregoing configuration isolates one heat source from another vertically and disposes the light guide member light source that consumes a large amount of electricity superiorly, so that heat-exhausting efficiency can be improved.

In the foregoing configuration, the light guide member light source is disposed at each left and right end portion of the light guide member, and each left and right end portion of the light guide member is located at the uppermost portion of the light guide member. The foregoing configuration enables the light guide member light source to be disposed at even a higher position in the housing and at each left and right end portion in the left-right direction, so that a thermal effect from the light guide member light source inside the housing can be reduced.

In the foregoing configuration, the main lighting body is a two-headlight type, the light guide member is formed into the co-shape to cover the peripheries of the two-headlight main lighting bodies, and the central portion of the light guide member is located at the frontmost portion. The foregoing configuration enables the light emitted from the light guide member light source to be efficiently brought to reach the central portion of the light guide member.

### BRIEF DESCRIPTION OF THE DRAWINGS

FIG. 1 is a left side elevation view of a motorcycle including a headlight according to an embodiment of the present invention.

FIG. 2 is a front elevation view of a front upper portion of the motorcycle.

FIG. 3 is a front elevation view of the headlight.

FIG. 4 is a front elevation view of the headlight, depicting a condition in which a lens and a housing cover have been removed from what is depicted in FIG. 3.

FIG. 5 is a front elevation view of the headlight, depicting a condition in which an extension has been removed from what is depicted in FIG. 4.

FIG. 6 is a perspective view of what is depicted in FIG. 5, as viewed from an obliquely superior side.

FIG. 7 is an enlarged view of major components of what is depicted in FIG. 5.

FIG. 8 is a view on arrow VIII in FIG. 5.

FIG. 9 is a view on arrow IX in FIG. 5.

### MODE FOR CARRYING OUT THE INVENTION

A specific embodiment to which the present invention is applied will be described below with reference to the accompanying drawings. Throughout the descriptions given hereunder, expressions indicating directions including front and rear, right and left, and upper and lower mean the same directions as those in a vehicle body unless otherwise specified. In the drawings, an arrow FR indicates an anterior direction of the vehicle body, an arrow UP indicates a superior direction of the vehicle body, and an arrow LH indicates a leftward direction of the vehicle body.

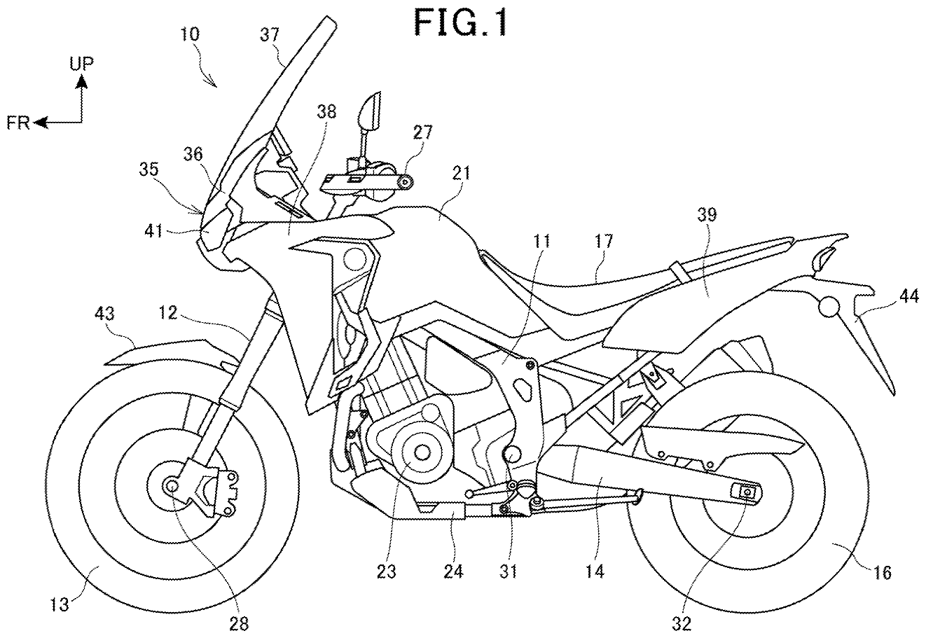

FIG. 1 is a left side elevation view of a motorcycle 10, which includes a headlight 41 according to an embodiment of the present invention.

The motorcycle 10 includes a vehicle body frame 11, a front wheel 13, a rear wheel 16, and a seat 17. The vehicle body frame 11 constitutes a framework. The front wheel 13 is supported at a front end portion of the vehicle body frame 11 via a front fork 12. The rear wheel 16 is supported at a lower portion of the vehicle body frame 11 via a swing arm 14. The seat 17 provides a place in which an occupant sits.

The motorcycle 10 is a saddle riding vehicle in which the occupant straddles the seat 17.

A fuel tank 21, which is disposed anterior to the seat 17, is supported at an upper portion of the vehicle body frame 11. An engine 23, which is disposed inferior to the fuel tank 21, is supported at a lower portion of the vehicle body frame 11. A skid plate 24, which is mounted on the vehicle body frame 11 to thereby cover the engine 23 from below, is disposed inferior to the engine 23.

The front fork 12 is steerably supported by a head pipe (not depicted) disposed at a front end portion of the vehicle body frame 11. A handlebar 27 is mounted at an upper portion of the front fork 12. The front wheel 13 is supported via an axle 28 at a lower end portion of the front fork 12.

The swing arm 14 has a front end portion oscillatably supported by a pivot shaft 31, which is disposed at a lower portion of the vehicle body frame 11. The swing arm 14 has a rear end portion supporting the rear wheel 16 via an axle 32.

A vehicle body cover 35 covers the vehicle body frame 11 and different parts of the vehicle body.

The vehicle body cover 35 includes a front cover 36, a windscreen 37, a pair of left and right radiator shrouds 38, an a pair of left and right rear covers 39.

The front cover 36 covers a front portion of the vehicle body. The headlight 41 is disposed in the front cover 36. The windscreen 37 is mounted at an upper portion of the front cover 36. The left and right radiator shrouds 38 cover a radiator (not depicted) from left and right sides. The left and right rear covers 39 cover portions of the vehicle body frame 11 inferior to the seat 17 from sides.

The front wheel 13 is covered in a front fender 43 from above and the rear wheel 16 is covered in a rear fender 44 from above.

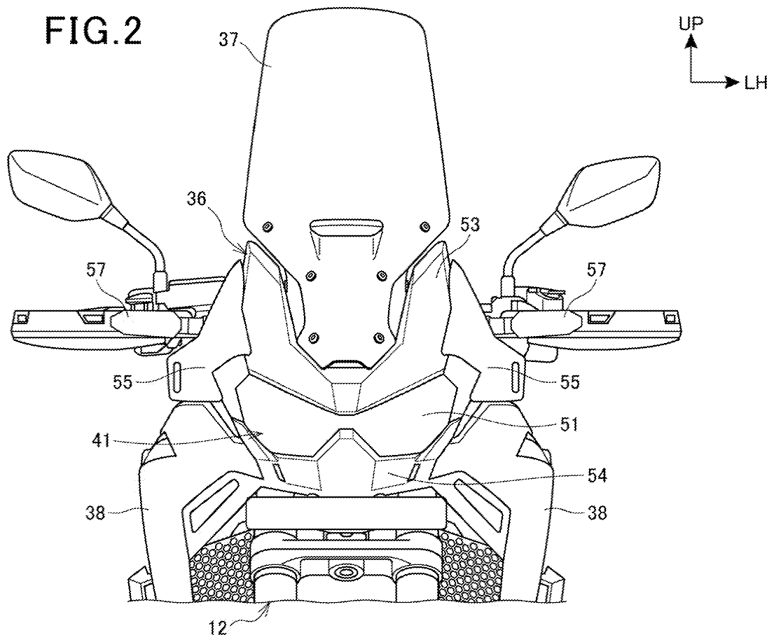

FIG. 2 is a front elevation view of a front upper portion of the motorcycle 10.

The headlight 41 includes a lens 51, which has a shape of spectacles integrating left and right portions.

The front cover 36 is disposed so as to surround the headlight 41. The front cover 36 includes an upper portion cover 53, a lower portion cover 54, and a pair of left and right side portion covers 55. The upper portion cover 53 is disposed superior to, the lower portion cover 54 is disposed inferior to, and the left and right side portion covers 55 are disposed on the left and right sides of, respectively, the headlight 41.

The windscreen 37 is mounted on the upper portion cover 53. The left and right radiator shrouds 38 have front end portions connected with the lower portion cover 54. A pair of left and right front blinkers 57 is mounted on the left and right side portion covers 55.

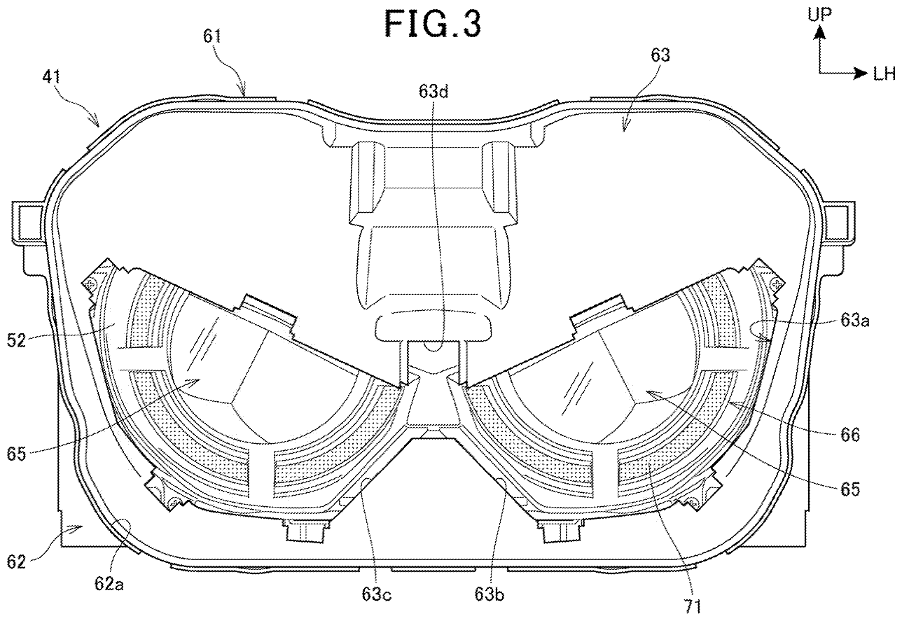

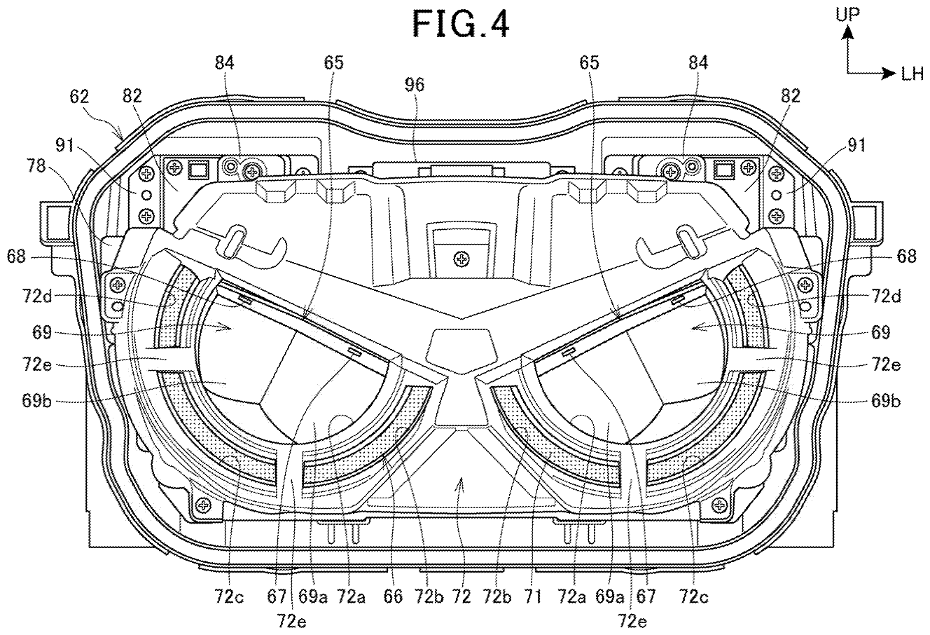

FIG. 3 is a front elevation view of the headlight 41. FIG. 4 is a front elevation view of the headlight 41, depicting a condition in which the lens 51 and a housing cover 63 have been removed from what is depicted in FIG. 3.

As depicted in FIG. 3, the headlight 41 includes the lens 51 and a housing 61. The housing 61 includes a housing main body 62 and the housing cover 63. The housing main body 62 constitutes a rear portion of the housing 61. The housing cover 63 is mounted on the housing main body 62 so as to close a front portion opening 62a in the housing main body 62.

The housing cover 63 has a lens opening portion 63a formed therein. The lens 51 is mounted on the housing cover 63 so as to close the lens opening portion 63a.

The lens opening portion 63a includes a left lighting body opening 63b, a right lighting body opening 63c, and a central opening 63d. The left lighting body opening 63b and the right lighting body opening 63c are each formed into a substantially semi-circular shape. The central opening 63d connects the left lighting body opening 63b with the right lighting body opening 63c.

Reference is made to FIG. 4. Main lighting bodies 65 including two headlights on the left and right and a subsidiary lighting body 66, which is disposed to surround the main lighting bodies 65, are disposed in the housing main body 62.

Each main lighting body 65 includes a low-beam light source 67, a high-beam light source 68, and a reflector 69. The low-beam light source 67 and the high-beam light source 68 each include a light-emitting diode (LED). The reflector 69 reflects light emitted from the low-beam light source 67 and the high-beam light source 68 to an anterior direction in the vehicle.

The high-beam light source 68 is disposed at a position obliquely superior to the low-beam light source 67 on an outer side.

The reflector 69 includes a low-beam reflection portion 69a and a high-beam reflection portion 69b. The low-beam reflection portion 69a reflects light emitted from the low-beam light source 67. The high-beam reflection portion 69b reflects light emitted from the high-beam light source 68. The high-beam reflection portion 69b is disposed at a position obliquely superior to the low-beam reflection portion 69a on an outer side.

The subsidiary lighting body 66 includes a light guide member 71. The light guide member 71 integrates left and right parts together and can emit light. The light guide member 71 has a portion thereof covered in a covering extension 72 from the front (from an anterior direction in the vehicle body; the same holds also in the following). The light guide member 71 is indicated by a plurality of dots (in FIGS. 3 to 9) to facilitate understanding of a shape thereof.

The extension 72 is mounted on a subsidiary lighting body support member 78, which will be detailed later. The extension 72 has a pair of left and right main lighting body opening portions 72a and a plurality of slits 72b, 72c, and 72d.

The left and right main lighting bodies 65 are exposed to the front through the left and right main lighting body opening portions 72a.

The slits 72b, 72c, and 72d are formed along edge portions on lower portions of the left and right main lighting body opening portions 72a.

The slits 72b, 72c, and 72d represent portions through which the light guide member 71 is exposed. A plurality of bridge portions 72e are formed, each being formed between each adjacent pair of the slits 72b, 72c, and 72d. The bridge portions 72e each extend across two edge portions which the slits 72b, 72c, and 72d face.

The light guide member 71 is partially covered in the extension 72 from the front as depicted in FIG. 4, so that the light guide member 71 can be given an accentuated light-emitting shape and a viewer can be given a novel impression.

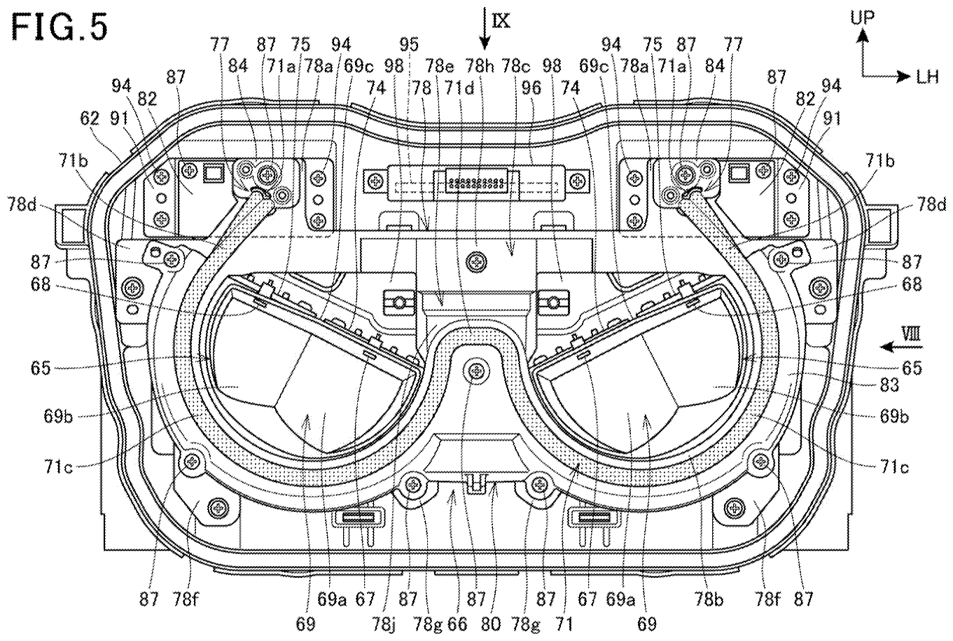

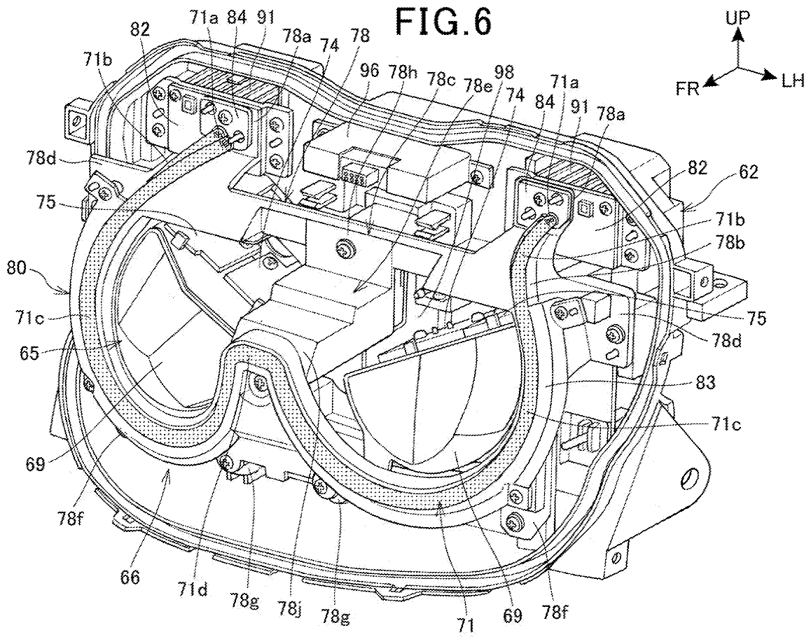

FIG. 5 is a front elevation view of the headlight 41, depicting a condition in which the extension 72 has been removed from what is depicted in FIG. 4. FIG. 6 is a perspective view of what is depicted in FIG. 5, as viewed from an obliquely superior side.

As depicted in FIGS. 3 to 5, the headlight 41 includes the housing 61, the lens 51, the left and right main lighting bodies 65, the subsidiary lighting body 66, and the extension 72.

As depicted in FIGS. 5 and 6, the low-beam light source 67 and the high-beam light source 68 of the main lighting body 65 are mounted on substrates 74 and 75, respectively, on an upper wall 69c of the reflector 69.

The reflector 69 has a substantially semi-circular shape in a front view. The upper wall 69c is flatly formed and inclined such that an end portion on the outside in a vehicle width direction is superior to an end portion on the inside in the vehicle width direction.

The substrates 74 and 75 are mounted on an upper surface of the upper wall 69c and are thus inclined. The substrate 75 is disposed obliquely superior to the substrate 74 on the outside in the vehicle width direction.

The subsidiary lighting body 66 includes a pair of light source groups 77 and an integrated light guide member molding 80. The light source groups 77 are disposed at upper portions of the housing main body 62 at left and right. The light guide member molding 80 is supported by the subsidiary lighting body support member 78, which is mounted on the housing main body 62. In the light guide member molding 80, the light guide member 71 illuminates with light emitted from the light source groups 77 at left and right.

The light source groups 77 each include a plurality of LED light sources. The LED light sources are mounted on each of a pair of left and right substrates 82.

The light guide member molding 80 integrally includes the light guide member 71, a curved portion mounting portion 83, and a pair of left and right end portion mounting portions 84.

The light guide member 71 is formed of a transparent resin. The light guide member 71 guides light from the light source groups 77 on the left and right and emits light. In a vehicle front view, the light guide member 71 is formed into an co-shape that extends continuously along peripheries of the main lighting bodies 65 (specifically, the reflectors 69). The light guide member 71 is formed into a circular shape (or an elliptic shape) in cross section excluding left and right upper end portions (end portions 71a). The light guide member 71 has ends with increasing widths toward the end portions 71a as if the ends were each divided into two. The light source groups 77 are disposed so as to be closer to end faces of the end portions 71a having wider widths.

The light guide member 71 includes a pair of left and right upper portion inclined portions 71b, a pair of left and right side portion curved portions 71c, and a center bent portion 71d.

The left and right upper portion inclined portions 71b extend, in a vehicle front view, obliquely inferiorly to the outside in the vehicle width direction from the end portions 71a on the left and right of the light guide member 71. The left and right side portion curved portions 71c extend, in the vehicle front view, so as to protrude inferiorly and to curve from lower end portions of the left and right upper portion inclined portions 71b. The center bent portion 71d is bent, in the vehicle front view, into an inverted-U shape with the left and right side portion curved portions 71c having end portions inside in the vehicle width direction merged and protruding superiorly.

The curved portion mounting portion 83 is formed integrally with the left and right side portion curved portions 71c on the outside in the vehicle width direction and on the lower side, and with the center bent portion 71d on the lower side, throughout the left and right side portion curved portions 71c and the center bent portion 71d of the light guide member 71. The curved portion mounting portion 83 is mounted on the subsidiary lighting body support member 78 with a plurality of screws 87.

The end portion mounting portions 84 represent plate-shaped portions integrally formed with the end portions 71a on both ends of the light guide member 71.

Rays of light emitted from the light source groups 77 on the left and right travel from the respective end portions 71a on both sides of the light guide member 71 toward the side of the center bent portion 71d. The rays of light from the light source groups 77 on the left and right reach the center bent portion 71d, so that the amount of light is prevented from being reduced and brightness is achieved. In addition, the light guide member 71 is continuous at the center bent portion 71d, so that light from the light guide member 71 is prevented from leaking.

The substrates 82, on which the left and right light source groups 77 are mounted, are mounted on heat sinks 91, which are disposed at upper end portions at left and right of the housing main body 62, by the screws 87. The heat sinks 91 at the left and right are mounted at upper portions at left and right of the housing main body 62 by a plurality of screws 94.

Because the subsidiary lighting body 66 is used as a daytime running light (DRL) that is lit up at all times during daytime, the left and right light source groups 77 are rated as having high power consumption and a great heat value. Mounting the substrates 82 on the heat sinks 91 thus allows the light source groups 77 to dissipate more heat, and temperature can be prevented from rising.

When outdoor brightness (sky illuminance) from evening to night is equal to or smaller than a predetermined value, for example, the brightness of the light source groups 77 decreases and the subsidiary lighting body 66 lights up with the low-beam light sources 67 of the main lighting bodies 65, thereby functioning as a low-beam lighting body.

The left and right light source groups 77 are disposed superior to the low-beam light sources 67 and the high-beam light sources 68 of the left and right main lighting bodies 65 and are disposed superior to the left and right high-beam light sources 68.

A control substrate box 96 is disposed between the left and right heat sinks 91. The control substrate box 96 houses a control substrate 95, which controls emission of light (controls current) of the low-beam light sources 67 and the high-beam light sources 68 of the main lighting bodies 65 and the light source groups 77 of the subsidiary lighting body 66. The control substrate box 96 is mounted at the upper portion of the housing main body 62 at a central portion in the vehicle width direction.

The reflectors 69 of the left and right main lighting bodies 65 are supported by a pair of left and right main lighting body support members 98. The main lighting body support members 98 are mounted on the housing main body 62.

The subsidiary lighting body support member 78 integrally includes a pair of left and right upper portion mounting portions 78a, a light guide member support portion 78b, a widthwise extension portion 78c, a pair of left and right side portion mounting portions 78d, a fore-aft extension portion 78e, a pair of left and right lower portion outside mounting portions 78f, and a pair of left and right lower portion inside mounting portions 78g.

The left and right upper portion mounting portions 78a are mounted, together with the left and right end portion mounting portions 84 of the light guide member 71 and the left and right substrates 82, on the left and right heat sinks 91.

The light guide member support portion 78b is formed along the light guide member 71 into the co-shape in the vehicle front view to thereby support the light guide member 71. The widthwise extension portion 78c extends in the vehicle width direction across left and right portions of the light guide member support portion 78b. The widthwise extension portion 78c has a central portion 78h mounted on the housing main body 62.

The left and right side portion mounting portions 78d protrude to the outside in the vehicle width direction from left and right side portions of the light guide member support portion 78b and are mounted on the housing main body 62. The fore-aft extension portion 78e protrudes anteriorly from a lower portion of the central portion 78h of the widthwise extension portion 78c to thereby extend in the fore-aft direction. The fore-aft extension portion 78e has a distal end portion 78j connected with a central portion of the light guide member support portion 78b.

The left and right lower portion outside mounting portions 78f protrude inferiorly from side portions on both sides of the light guide member support portion 78b and are mounted on the housing main body 62. The left and right lower portion inside mounting portions 78g protrude inferiorly from the light guide member support portion 78b, which is disposed inside the left and right lower portion outside mounting portions 78f in the vehicle width direction, and are mounted on the housing main body 62.

The curved portion mounting portion 83 of the light guide member molding 80 is mounted on the left and right side portion mounting portions 78d, the fore-aft extension portion 78e, the left and right lower portion outside mounting portions 78f, the left and right lower portion inside mounting portions 78g, and the distal end portion 78j of the fore-aft extension portion 78e, respectively, by the screws 87.

In FIGS. 4 and 5, the extension 72 covers, from the front, parts of the light guide member 71, specifically, the left and right end portions 71a, the left and right upper portion inclined portions 71b, parts of the left and right side portion curved portions 71c (portions posterior to each of the bridge portions 72e (posterior in the vehicle body)), and the center bent portion 71d.

The extension 72 further covers, from the front, the substrates 74 and 75 on the left and right, the widthwise extension portion 78c, the fore-aft extension portion 78e, and other parts of the subsidiary lighting body support member 78, and most of the curved portion mounting portion 83 of the light guide member molding 80.

In FIGS. 3 and 4, the housing cover 63 covers, from the front, the left and right low-beam light sources 67, and the left and right high-beam light sources 68.

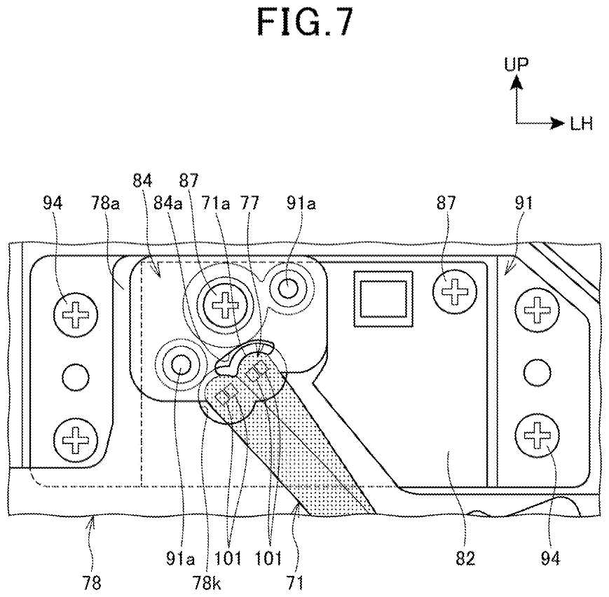

FIG. 7 is an enlarged view of major components of what is depicted in FIG. 5.

The subsidiary lighting body support member 78 includes the pair of left and right upper portion mounting portions 78a (FIG. 7 depicts only the upper portion mounting portion 78a on the left-hand side), which protrude superiorly. The left and right upper portion mounting portions 78a and the left and right end portion mounting portions 84 (FIG. 7 depicts only the end portion mounting portion 84 on the left-hand side) of the light guide member 71 are fastened jointly with the substrates 82 to the heat sinks 91 by the screws 87.

The heat sink 91 is provided with a pair of positioning pins 91a. The positioning pins 91a correctly position the substrate 82, the upper portion mounting portion 78a, and the end portion mounting portion 84.

The upper portion mounting portion 78a has an opening portion 78k, through which the light source group 77 on the substrate 82 is made to face the end portion 71a of the light guide member 71.

The end portion 71a of the light guide member 71 has a cross section having, what is called, a “pear-shaped” outline with two circles partially overlapping each other. The end portion 71a thus has a cross-sectional area greater than other portions of the light guide member 71.

The end portion mounting portion 84 of the light guide member 71 has an opening portion 84a. The opening portion 84a is formed at a position adjacent to the end portion 71a. The opening portion 84a allows the end portion 71a and the light source group 77 to face an inside of the housing 61 via the opening portion 78k in the upper portion mounting portion 78a.

The light source group 77 includes a single or a plurality of LED light sources 101. The single or a plurality of LED light sources 101 are disposed in each of the two circles of the end portion 71a of the light guide member 71 in a front view. Alternatively, the light source group 77 may be a single light source 77 disposed within the two circles of the end portion 71a of the light guide member 71 in a front view.

The enlarging of the cross-sectional area of the end portion 71a of the light guide member 71 enables a greater number of LED light sources 101 to face the end portion 71a of the light guide member 71. The amount of light to be guided can thereby be further increased, and the light guide member 71 can be illuminated even more brightly.

The provision of the opening portion 84a in the end portion mounting portion 84 can promote heat dissipation (heat dissipation by radiation and convection of heat) from the light source groups 77 into the housing 61, so that the temperature of the light source groups 77 can be prevented from rising.

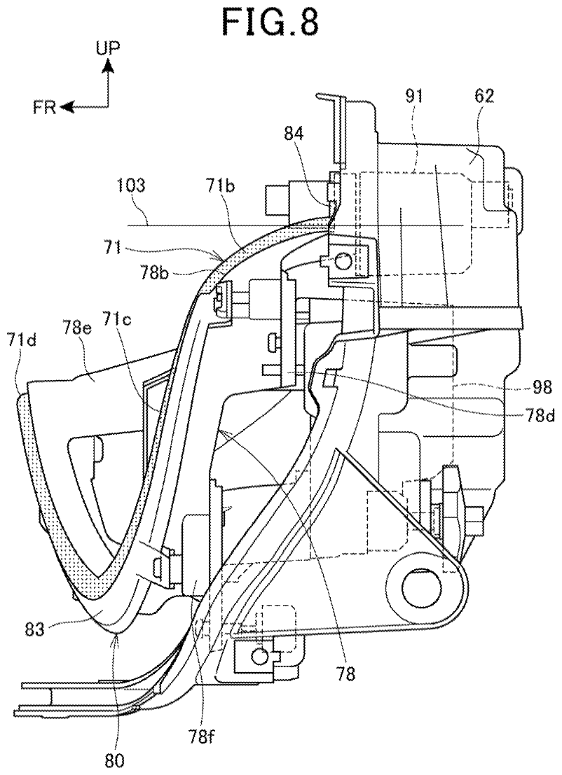

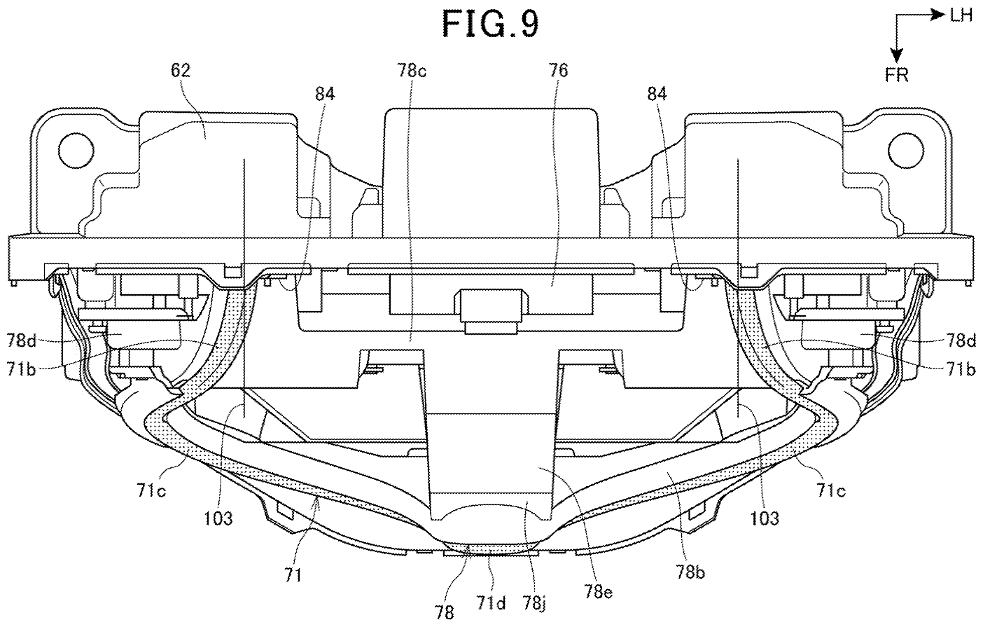

FIG. 8 is a view on arrow VIII in FIG. 5. FIG. 9 is a view on arrow IX in FIG. 5.

As depicted in FIG. 8, in a vehicle side view, the upper portion inclined portion 71b of the light guide member 71 extends along the vertical line 103 that extends from the end portion 71a (see FIG. 7) in the fore-aft direction (a straight line corresponding to an optical axis of the LED light source 101 (see FIG. 7)) before curving inferiorly. In the vehicle side view, the side portion curved portion 71c extends from an end portion of the upper portion inclined portion 71b inferiorly and obliquely anteriorly and is bent to further extend superiorly and obliquely anteriorly, before reaching the center bent portion 71d.

As depicted in FIG. 9, in a plan view, the upper portion inclined portion 71b of the light guide member 71 extends along the vertical line 103 from the end portion 71a (see FIG. 7) before curving to the outside in the vehicle width direction. In the plan view, the side portion curved portion 71c extends from the end portion of the upper portion inclined portion 71b and curves further to the outside in the vehicle width direction before curving toward the inside in the vehicle width direction. The side portion curved portion 71c extends obliquely anteriorly toward the inside in the vehicle width direction. The side portion curved portion 71c curves anteriorly upon approaching the center bent portion 71d and eventually reaches the center bent portion 71d.

In FIGS. 8 and 9, the center bent portion 71d is located at a frontmost portion of the light guide member 71.

The light guide member 71, because extending in all points thereof anteriorly from the end portion 71a, can efficiently guide light from the left and right light source groups 77 (see FIG. 5) to the center bent portion 71d and prevent the light from leaking. Thus, the amount of light can be prevented from gradually decreasing from the end portion 71a toward the center bent portion 71d and the amount of light on the side of the center bent portion 71d can be obtained.

As described with reference to FIGS. 3 to 5, the headlight 41, as the lighting apparatus, includes the housing 61, the lens 51, the low-beam light sources 67 and the high-beam light sources 68 as the main lighting body light sources, the reflectors 69, the light guide member 71, and the extension 72.

The lens 51 covers the front surface of the housing 61. The low-beam light sources 67 and the high-beam light sources 68 are housed in the housing 61 and emit light. The reflectors 69 reflect light from the low-beam light sources 67 and the high-beam light sources 68 anteriorly.

The light guide member 71 is disposed around the reflectors 69. The extension 72 partially covers the light guide member 71 from the front.

The light guide member 71 and the light source groups 77, which serve as the light guide member light sources emitting light to be guided to the light guide member 71, constitute the subsidiary lighting body 66. The light source groups 77 are disposed at the upper end portions of the light guide member 71.

The light source groups 77 consume electricity more than the low-beam light sources 67 and the high-beam light sources 68 do. The substrates 82, on which the light source groups 77 are mounted, are mounted together with the heat sinks 91 on the housing 61.

The foregoing configuration, in which the light source groups 77 are disposed at the upper end portions of the light guide member 71 and the light source groups 77, which consume a large amount of electricity, are mounted together with the heat sinks 91 on the housing 61, allows a thermal effect inside the headlight 41, as the lighting apparatus, to be reduced.

As depicted in FIGS. 5, 8, and 9, the light guide member 71 extends from the light source groups 77 along the straight line 103, which serves as the optical axis of the light source groups 77, in areas near the light source groups 77.

The foregoing configuration allows light leak from the light guide member 71 to be reduced and the light guide member 71 to be illuminated even more brightly.

As depicted in FIG. 5, the light source groups 77 are disposed to be offset vertically with respect to the low-beam light sources 67 and the high-beam light sources 68 and the light source groups 77 are disposed superior to the low-beam light sources 67 and the high-beam light sources 68.

The foregoing configuration isolates one heat source from another vertically and disposes the light source groups 77, which consume a large amount of electricity, superiorly, so that heat-exhausting efficiency can be improved.

The light source groups 77 are disposed at the left and right end portions of the light guide member 71, and the left and right end portions of the light guide member 71 are located at the uppermost portions of the light guide member 71.

The foregoing configuration enables the light source groups 77 to be disposed at even higher positions in the housing 61 and at left and right end portions in the left-right direction, so that a thermal effect from the light source groups 77 inside the headlight 41 can be reduced.

As depicted in FIGS. 5, 8, and 9, the main lighting bodies 65 are a two-headlight type, the light guide member 71 is formed into the co-shape to cover the peripheries of the two-headlight main lighting bodies 65, and the center bent portion 71d, as the central portion of the light guide member 71, is located at a frontmost portion.

The foregoing configuration enables the light emitted from the light source groups 77 to be efficiently brought to reach the central portion of the light guide member 71.

It should be understood that the embodiment of the invention described above is illustrative only and not limiting, and various changes in form and detail may be made therein without departing from the spirit and scope of the invention.

In addition, the present invention can be applied to, not only the motorcycle 10, but also a saddle riding vehicle including a type other than the motorcycle 10.

### DESCRIPTION OF REFERENCE SYMBOLS

10 Motorcycle (saddle riding vehicle)
51 Lens
61 Housing
65 Main lighting body
66 Subsidiary lighting body
67 Low-beam light source (main lighting body light source)
68 High-beam light source (main lighting body light source)
69 Reflector
71 Light guide member
71d Center bent portion (central portion)
72 Extension
77 Light source group (light guide member light source)
91 Heat sink
103 Straight line (optical axis)

1. A lighting apparatus comprising:
a housing;
a lens that covers a front surface of the housing;
a main lighting body housed in the housing, the main lighting body emitting light;
a reflector that reflects light from main lighting body light source included in the main lighting body anteriorly;
a light guide member disposed around the reflector; and
an extension that partially covers the light guide member from a front, wherein
the light guide member, and a light guide member light source that emits light to be guided to the light guide member, constitute a subsidiary lighting body,
the light guide member light source is disposed at an upper end portion of the light guide member,
the light guide member light source consumes electricity more than the main lighting body light source does, and
a substrate, on which the light guide member light source is mounted, is mounted together with a heat sink on the housing.

2. The lighting apparatus according to claim 1, wherein
the light guide member extends from the light guide member light source along an optical axis of the light guide member light source in an area near the light guide member light source.

3. The lighting apparatus according to claim 1, wherein
the light guide member light source is disposed to be offset vertically with respect to the main lighting body light source, and
the light guide member light source is disposed superior to the main lighting body light source.

4. The lighting apparatus according to claim 1, wherein
the light guide member light source is disposed at each left and right end portion of the light guide member, and
each left and right end portion of the light guide member is located at an uppermost portion of the light guide member.

5. The lighting apparatus according to claim 1, wherein
the main lighting body is a two-headlight type,
the light guide member is formed into an ω-shape to cover peripheries of the two-headlight main lighting bodies, and
a central portion of the light guide member is located at a frontmost portion.
